(19) United States
(12) Patent Application Publication
(10) Pub. No.: US 2023/0392056 A1
(43) Pub. Date: Dec. 7, 2023

(54) FOIL TAPE

(71) Applicant: Berry Global, Inc., Evansville, IN (US)

(72) Inventor: Roland H. HORST, Franklin, KY (US)

(21) Appl. No.: 18/330,011

(22) Filed: Jun. 6, 2023

Related U.S. Application Data
(60) Provisional application No. 63/349,709, filed on Jun. 7, 2022.

(51) Int. Cl. C09J 153/02; C09J 7/35; C09J 7/38; C09J 7/28

(52) U.S. Cl. CPC C09J 153/02; C09J 7/35; C09J 7/387; C09J 7/28

(57) ABSTRACT

An adhesive tape includes a foil layer and an adhesive layer. The adhesive tape satisfies the physical test requirements of the UL 181A foil tape specification.

### PRIORITY CLAIM

This application claims priority under 35 U.S.C. § 119(e) to U.S. Provisional Application No. 63/349,709, filed Jun. 7, 2022, which is expressly incorporated by reference herein.

### BACKGROUND

The present disclosure relates to tapes, and particularly to adhesive tapes. More particularly, the present disclosure relates to foil tapes.

### SUMMARY

According to the present disclosure, an adhesive tape includes a foil layer and a rubber-based adhesive layer.

In illustrative embodiments, the rubber-based adhesive layer may include a formulation having one or more raw ingredients having varying concentrations. The raw ingredients may include one or more of an adhesion promoter, a tackifier resin, an endblock modifier, a liquid tackifier, additives, and so forth. The rubber-based adhesive layer permits the adhesive tape to satisfy the physical test requirements of the UL 181A foil tape specification.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of one embodiment of an adhesive tape of the present disclosure which passed UL 181A certification being applied to seal a joint between two sections of HVAC duct;

FIG. 2 is a diagrammatic side view of the adhesive tape of FIG. 1 showing that the adhesive tape includes, from top to bottom, a foil layer, a rubber based adhesive, and a release liner;

FIG. 3 is a perspective view of the adhesive tape of FIG. 1 showing the adhesive tape after being torn about a cleavage line with no delamination of the adhesive from the foil when tearing;

FIG. 4A is a schematic illustration of a styrenic block copolymer (SBC) of the adhesive of the present disclosure;

FIG. 4B is a schematic illustration of a SBC spherical domain structure of the adhesive of the present disclosure;

FIG. 5 is a perspective view of a sample of a tape in which a comparative adhesive undesirably delaminates from the foil;

FIG. 5A is a table illustrating an example adhesive composition to evaluate impact of an original formula (1) of an adhesive having a tackifier concentration thereof reduced by 50% (1A), and by 25% (1B);

FIG. 5B is a table illustrating another example adhesive composition to evaluate impact of an original formula (1) of an adhesive having a tackifier concentration thereof reduced by 50% (1A), and by 25% (1B);

FIGS. 6A-6C are graphical representations of the effect of an adhesion promoter on flow behavior of the adhesive of the present embodiments;

FIGS. 7A-7C are graphical representations of the effect of a plasticizer on flow behavior of the adhesive of the present embodiments;

FIGS. 8A-8C are graphical representations of the effect of the plasticizer on additional flow behavior of the adhesive of the present embodiments;

FIGS. 9A-9C are graphical representations of the effect of a tackifier resin on flow behavior of the adhesive of the present embodiments;

FIGS. 10A-10C are graphical representations of the effect of an end-block modifier on flow behavior of the adhesive of the present embodiments;

FIGS. 11A-11C are graphical representations of the effect of a liquid tackifier on flow behavior of the adhesive of the present embodiments; and

FIGS. 12A-12C illustrate tables of trials for modified adhesive concentrations discussed in Example 6.

### DETAILED DESCRIPTION

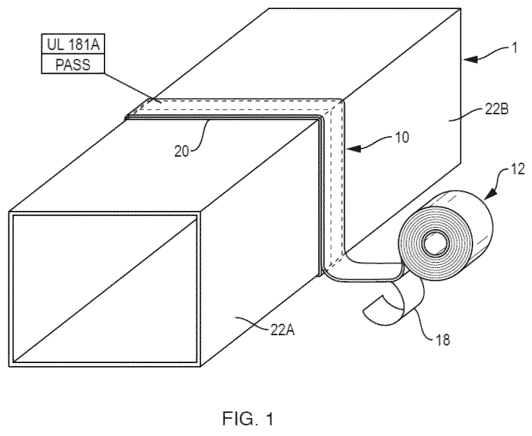

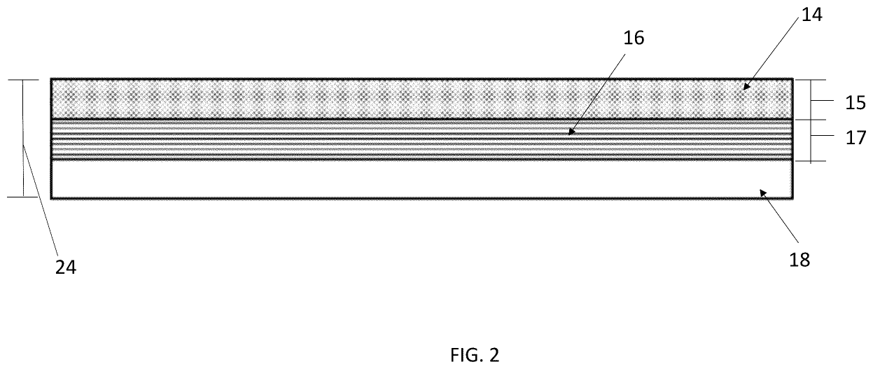

An adhesive tape 10, in accordance with the present disclosure, includes a foil layer 14, an adhesive layer 16, and a release liner 18 as shown in FIG. 2. The adhesive tape 10 is used, for example, to seal a joint 20 formed between two sections 22A and 22B of HVAC duct as shown in FIG. 1. The adhesive layer 16 is formed from a rubber-based adhesive formulation that allows the adhesive tape 10 to satisfy the physical test requirements of the UL 181A foil tape specification.

In exemplary embodiments, the adhesive layer is configured to provide adhesion means for bonding to an object, with the adhesion means being UL 181A compliant. For example, the present disclosure provides an adhesive tape comprising a rubber-based adhesive layer and a foil layer. Specifically, in some embodiments, the rubber-based adhesive may be a styrenic block copolymer (SBC) based hot melt adhesive that satisfies the physical test requirements of the UL 181A foil tape specification. Optionally, a release liner may be included.

FIG. 1 illustrates an exemplary embodiment of a tape 10 of the present disclosure being applied to a duct system 11. As shown, the tape 10 of the present disclosure may have high tack for use in duct sealing applications, e.g., connecting two duct sections 22A and 22B to one another, as well as fixing or patching in duct systems, sealing joints when building ducts out of duct board, connection of different ducts, and/or cuts into the duct board, among others. For example, in some embodiments, the tape 10 may exhibit sufficient tackiness during application without decomposing and/or delaminating when subjected to various environmental stresses, e.g., heat, moisture, decomposition, or load stresses, e.g., shear forces, perforation, and so forth. The tape 10 may be applied from a roll 12, as shown, though, in some embodiments, the tape may be manufactured in individual sheets, strips, and/or the like.

The adhesive tape 10 of the present embodiments may be comprised of multiple layers. FIG. 2 illustrates the layers of the adhesive tape 10 in greater detail. As shown, the tape 10 may include the first layer 14 comprising a metal, and the second layer 16 comprising an adhesive that is directly adjacent to the first layer 14. The metal of the first layer 12 may include a foil, e.g., aluminum, which forms the structural backbone of the tape.

The first layer 14 has a thickness 15. In some embodiments, the thickness 15 of the first layer 14 may be approximately in a range of about 1 mils to about 3 mils, about 1.5 mils to about 2.5 mils, and/or about 1.9 mils to about 2.1 mils.

As mentioned above, the adhesive layer 16 may be adjacent to the first layer 14. The second layer 16 may comprise an adhesive. The adhesive of the second layer 14 may be rubber-based, e.g., made of a synthetic rubber or a natural rubber. In some embodiments, the adhesive may be a hot melt adhesive. In one example, the adhesive may be selected based on the bond strength/release characteristics used in various applications. For example, in some embodiments, the adhesive may be coated onto the foil of the first layer 14 to form the adhesive tape 10. In some embodiments, the adhesive of the second layer 16 may extend between the first layer 14 and a third layer 18 to interconnect the first layer 14 and the third layer 18 as shown in FIG. 2.

The second layer 16 has a thickness 17. In one example, the thickness 17 about 2 mil. In another example, the thickness 17 is less than about 2 mils. In another example, the thickness 17 is about 1.2 mils, about 1.4 mils, about 1.5 mils, about 1.6 mils, about 1.8 mils, or about 2 mil. In another example the thickness 17 is about 3 mils, about 2.8 mils, about 2.6 mils, about 2.4 mils, or about 2.2 mils. In another example, the thickness 17 is about 1.2 mils to about 3 mil. In another example, the thickness 17 is about 1.8 mils to about 2.2 mils thick.

The adhesive tape 10 may optionally include a third layer 18. The third layer may be adjacent to the second layer 16 so as to contact the second layer. The third layer 18 may include a release liner that is separable from the adhesive layer to expose the adhesive layer to the environment for adhering the tape. In some embodiments, the third layer 18 may be paper coated with a silicone release agent on the adhesive side such that it attaches to the adhesive layer 16 to prevent the adhesive from attaching to surfaces and/or other portions of the adhesive layer until desired. In some embodiments, the third layer 18 may extend along a length of the second layer 16 with a surface that is configured to detach from the adhesive prior to adhering the tape 10 onto another surface. Once detached, the third layer 18 may be discarded and/or recycled.

Comparative foil tapes having a release liner that uses an acrylic-based adhesive. Acrylic-based adhesives are expensive to manufacture, which produces a need for alternative adhesives for use in tapes to keep costs down. Hot melt adhesives may be cheaper to produce and compound as compared to acrylics, as no solvent is used to prepare the hot melt adhesive. Moreover, hot melt adhesives have a production rate of 250 feet per minute, as compared to 90-120 feet per minute for acrylic-based adhesives. Comparative hot melt adhesives tend to exhibit poor shear adhesion, shear strength, and overall performance. Moreover, performance of comparative hot melt adhesives may degrade with time and at high temperatures. Hot-melt adhesives of the present disclosure address the deficiencies of comparative hot-melt adhesives while realizing the benefits.

The adhesive tape 10 has a tape thickness 24 as shown in FIG. 2. In one example, the tape thickness 24 is less than about 7 mils. In another example, the tape thickness 24 is less than about 6 mils. In another example, the tape thickness 24 is about 3 mils, about 3.1 mils, about 3.2 mils, about 3.3 mils, about 3.4 mils, about 3.6 mils, about 3.8 mils, about 4 mils, about 4.2 mils, about 4.4 mils, about 4.6 mils, about 4.8 mils, about 4.9 mils, about 5 mils, about 5.1 mils, about 5.2 mils, about 5.3 mils, about mils, about 5.6 mils, about 5.8 mils, about 6 mils, about 6.5 mils, or about 7 mils. In another example, the tape thickness 24 is in a range or about 3 mils to about 7 mils, about 4 mils to about 7 mils, about 4 mils to about 6 mils, or about 4.6 mils to about 5.4 mils. In another example, the tape thickness 24 is about 5.1 mils. In embodiments in which the tape thickness 24 is about 7 mils, for example, the thickness 17 of the second layer 16 is about 4 mils and a thickness of the third layer 18 is about 3 mils.

Adhesive tapes may be subjected to one or more testing standards to determine a safety profile of the tape. For example, performance characteristics of the tape may measure tensile strength, percent elongation at failure, and peel strength, with peel strength being tailored to the specific application of the tape. In some exemplary embodiments, the tape may be UL 181A certified and/or compliant. UL 181A compliance is a standard for factory-made air ducts and connectors to provide safety and resistance to failure when attached thereto. For example, when testing for UL 181A certification tapes may be tested for tensile strength, adhesion strength, shear adhesion at room temperature under a ten-pound load, shear adhesion at 150 degrees Fahrenheit under a five-pound load, peel adhesion at various angles, tackiness, surface burning characteristics, mold growth, humidity testing, and sealing capabilities when submitted to changing air pressures in the duct, among others.

UL 181A Physical Test Requirements for the adhesive tape of the present disclosure is summarized in detail in Table A below:

TABLE A

| Physical Test | Spec Minimum Requirement |
|---|---|
| Adhesion to Steel | >60 oz/inch |
| Adhesion to Tape Backing | N/A |
| Shear Adhesion at RT, 10 lb Load | >120 hours (<1/32″ Slip) |
| Shear Adhesion at 150 F., 5 lb Load | >6 hours (<1/32″ Slip) |

As shown, the tape 10 of the present embodiments has at least an adhesion to steel of greater than 60 oz/inch, a shear adhesion at room temperature under a ten-pound load of greater than 120 hours while having less than 1/32-inch slip, and a shear adhesion at 150 degrees Fahrenheit under a five-pound load of greater than six hours while having less than 1/32-inch slip. Additional requirements for UL 181A certification may be found in the document entitled “UL 181A Standard For Safety—Closure Systems for Use with Rigid Air Ducts,” the contents of which are incorporated by reference herein in their entirety in the Appendix.

The adhesive tape 10 has a measurable adhesion to steel. An adhesion to steel value may indicate how well adhesive tape 10 would bond to steel. Adhesion of the tape to a variety of substrates, such as, aluminum and other metals, concrete, paper, duct board, or wood can be tested. Due to the duct board having a surface made out of aluminum foil, adhesion to steel is a good indicator for adhesion of the tape of the present embodiments to duct board. In some embodiments, adhesive tape 10 has an adhesion to steel per inch that is greater than about 60 oz., greater than about 70 oz., or greater than about 80 oz., as measured by PSTC-101 (Pressure Sensitive Tape Council Test). In some embodiments, the adhesion to steel for adhesive tape 10 is about 60 oz., about 62 oz., about 64 oz., about 66 oz., about 68 oz., about 70 oz., about 75 oz., about 80 oz., or about oz., as measured by PSTC-101. In some embodiments, adhesive tape 10 has an adhesion to steel in a range of about 60 oz. to about 90 oz., about 60 oz. to about 85 oz., about 60 oz. to about 80 oz., about 60 oz. to about 75 oz., about 60 oz. to about 70 oz., or about 60 oz. to about 65 oz., as measured by PSTC-101. In some embodiments, adhesive tape 10 has a minimum adhesion to steel of about 60 oz., as measured by PSTC-101.

In some embodiments, preparation of the adhesive may include a proportion of approximately 100 grams of raw ingredients in combination with approximately 150 grams of liquid Toluene. The raw ingredients and the toluene mixture may then be placed onto a rolling mixer to make a complete homogeneous mixture. Once sufficiently homogenized, the mixture may pass through a drawdown instrument roll over roll, and heated in ovens to form the adhesive layer 16. In another exemplary embodiment, the adhesive can be heated and applied as a melt without the use of a solvent, e.g., toluene.

The adhesive layer 16 may be added to the foil layer 14. In some embodiments, the adhesive layer 16 may be laminated to the foil layer 14 to form the adhesive tape 10. Lamination of the first and second layers may occur by any suitable technique.

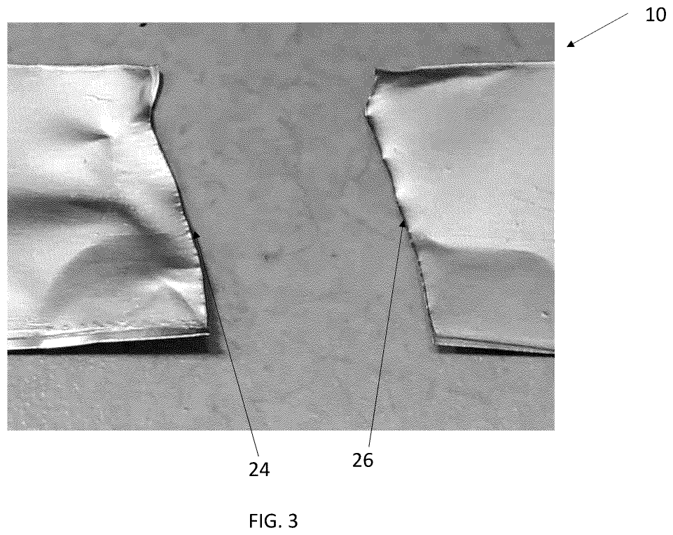

In some embodiments, the tape of the present embodiments may be configured to minimize stretching thereof. FIG. 3 illustrates an exemplary embodiment of a desired tearing pattern of the adhesive tape of the present embodiments. Illustratively, minimizing the stretching may result in a clean tear in the cross-machine direction. As described herein, the adhesive tape 10 is configured so that cleaved edges 24, 26 of the pieces of torn tape 10 are generally mirror images of one another. As an example, formed cleaved edges 24 and 26 may be close to parallel with one another, as shown, with each piece of tape having the foil layer 14 and the adhesive layer 16 thereon.

Formulation

Formulation of the adhesive of the second layer 16 may include a combination of one or more raw ingredients. In exemplary embodiments, the formulation of the adhesive of the second layer 16 may include raw ingredients such as oil, Styrenic Block Copolymer (SBC), tackifier, endblock modifiers, and/or additives, among other ingredients.

The SBC may be the base of the adhesive of the adhesive tape 10 of the present disclosure. The SBC may include a synthetic rubber that serves as a substitute to acrylic used in acrylic-based tapes. Some non-limiting examples of the SBC of the tape of the present disclosure, may include SIS High Tri-block compounds such as Dexco DPX 600 available from TSRC, Vector 4186 available from TSRC Specialty Materials LLC, combinations thereof, and/or any other suitable SBC. Any suitable tri-block or radial SIS block-copolymers may potentially be used, such as Kraton D1126P, for ex ample.

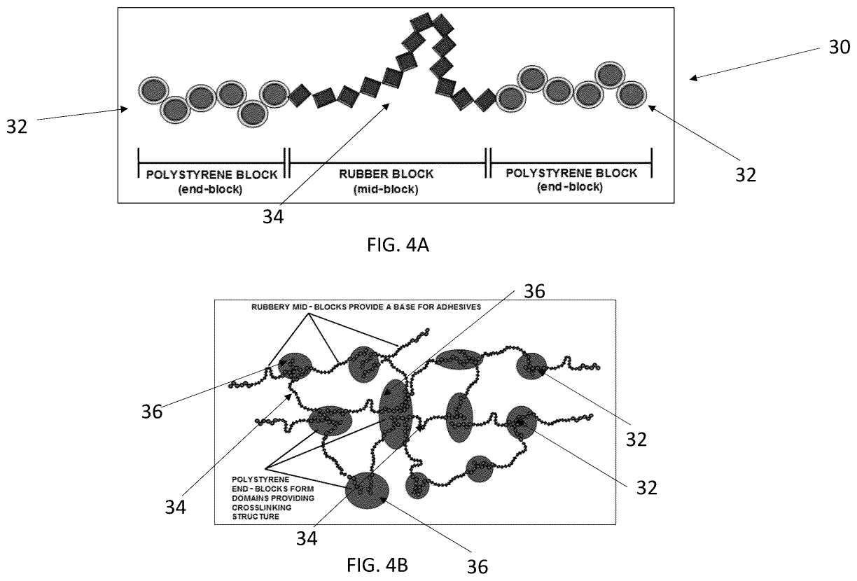

FIGS. 4A-4B illustrate the molecular structure of a single strand of SBC in greater detail. As shown, the SBC 30 may be a tri-block copolymer 30 comprised of polystyrene endblocks 32 surrounding an isoprene, e.g., rubber block, mid-block 34. Styrene and isoprene are incompatible and undergo microphase separation, which lead to the SBC tri-blocks form domains of like-monomers, as shown in FIG. 4B. The rubber mid-block 34 may provide a base for adhesives while the polystyrene end-blocks 32 form domains or network junctions 36 providing crosslinking structure. The styrene endblocks 32 may be hard and add strength to the molecular structure of the adhesive.

In some embodiments, the SBC may be a di-block copolymer having a single endblock and a single mid-block. The di-blocks may provide better stickiness than tri-blocks, while tri-blocks provide superior strength as compared to di-blocks. A mixture of di-blocks and tri-blocks provide a balance of properties of the resultant adhesive. For example, when forming the adhesive, the mid-block of a first SBC strand may interface with a mid-block and/or an endblock of another SBC strand in a domain structure of the resultant adhesive. Alternating these di-blocks with di-blocks and tri-blocks of another SBC strand may form domains having a cross-linking structure may allow the adhesive to have superior tackiness while minimizing risk of delamination and failure after adhesion. In some exemplary embodiments, synthetic rubbers such as DPX 600, which has a composition of 20.5% styrene, 30% di-block, and/or Vector 4186, which has a composition of 17.2% styrene, 72.8% di-block, may be used. Use of these synthetic rubbers have shown better adhesive performance, as shown in greater detail below.

The endblocks 32 may reinforce the strength of the tri-block copolymer 30 to raise the melting point thereof. Specifically, increasing a size and/or number of the network junctions 36 raises the overall melting point of the adhesive, resulting in superior performance. In exemplary embodiments, the mid-blocks 34 may form the tacky and rubbery continuous phase and control tack and adhesion.

Concentrations of the SBC in the adhesive may vary. In exemplary embodiments, a styrenic block copolymer in approximately in a range of about 30% to about 60% of the total weight percentage of the adhesive, approximately in a range of about 33% to about 60% of the total weight percentage of the adhesive, approximately in a range of about 33% to about 55.5% of the total weight percentage of the adhesive, approximately in a range of about 33.5% to about 55.5% of the total weight percentage of the adhesive, approximately in a range of about 33.8% to about 55.5% of the total weight percentage of the adhesive, approximately in a range of about 45.5% to about 50% of the total weight percentage of the adhesive, and/or approximately in a range of about 46.2% to about 46.5% of the total weight percentage of the adhesive.

In some embodiments, an endblock modifier may be added to the SBCs to further enhance the structure thereof. For example, the endblock modifier may further extend a temperature range of the hot melt adhesive to raise the melting point thereof. Some non-limiting examples of endblock modifiers may be Kristalex 5140 available from Eastman Chemical Company, Endex 155 available from Eastman Chemical Company, and Plastolyn 290LV available from Eastman Chemical Company, the compositions of which are discussed below in greater detail. A concentration of the endblock modifier may be in approximately in a range of about 5% to about 7% of the total weight percentage of the adhesive, approximately in a range of about 7% to about 10% of the total weight percentage of the adhesive, and/or approximately in a range of about 7.6% to about 9.5% of the total weight percentage of the adhesive.

Properties of the adhesive may be adjusted by adding additional ingredients thereto. For example, in some embodiments, one or more tackifier resins may be added to the SBCs to improve performance of the adhesive. In some embodiments, addition of a tackifier may improve peel adhesion, tack, and high temperature performance of the adhesive.

In some embodiments, the tackifier added to the adhesive may include an adhesion promoter therein. The adhesion promoter may be a phenolic resin, e.g., a thermoplastic alkylphenolic resin such as HRJ-2765 available from SI Group, Inc., though other suitable compounds may be used in addition and/or in lieu of the compounds listed above. A concentration of the adhesion promoter may be in approximately in a range of about 1% to about 2% of the total weight percentage of the adhesive, approximately in a range of about 1.1% to about 1.5% of the total weight percentage of the adhesive, and/or approximately in a range of about 1.14% to about 1.18% of the total weight percentage of the adhesive.

In exemplary embodiments, the tackifier added to the adhesive may include a plasticizer. The plasticizer may be Santicizer 160 available from Era Polymers Pty. Ltd., which is a Butyl benzyl phthalate polymer modifier that is a low viscosity fluid at room temperature, though other suitable compounds in addition and/or in lieu of the compounds listed above may be used.

In exemplary embodiments, the tackifier added to the adhesive may include a tackifier resin. The tackifier resin may be Escorez 2203 available from ExxonMobil Chemical, P-95 Rosin available from Summit PineChem, and/or Piccotex 100 available from Eastman Chemical Company, which are modified aliphatic hydrocarbon resins, though other suitable compounds may be used in addition and/or in lieu of the compounds listed above. A concentration of the tackifier resin may be approximately in a range of about 20% to about 35% of the total weight percentage of the adhesive, approximately in a range of about 22.5% to about 31.27% of the total weight percentage of the adhesive, and/or approximately in a range of about 22.7% to about 28.4% of the total weight percentage of the adhesive.

In exemplary embodiments, a plurality of tackifier resins may be used. For example, Escorez 2203 and Piccotex 100 may be used in a single adhesive. In such embodiments, an amount of Escorez 2203 may be approximately in a range of about 22.7% to about 28.4% of the total weight percentage of the adhesive. Moreover, in some embodiments, an amount of Piccotex may be approximately in a range of about 2.3% to about 2.9% of the total weight percentage of the adhesive.

In exemplary embodiments, the tackifier added to the adhesive may include a liquid tackifier. The liquid tackifier may include Nevtac 10 available from Neville Chemical Company, which is a C5 liquid tackifying hydrocarbon resin, though other suitable compounds may be used in addition and/or in lieu of the compounds listed above. While concentration may be presented in terms of weight percentages, parts per hundred rubber (PHR) may also be used, as discussed in the tables and the disclosure below, to quantify an amount of each compound in the adhesive.

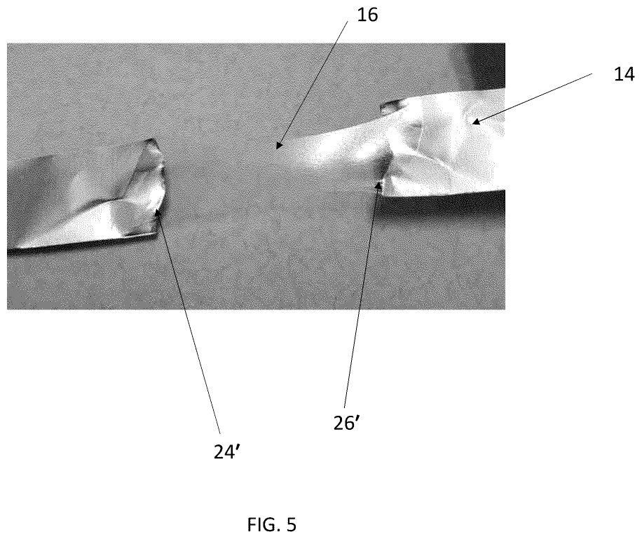

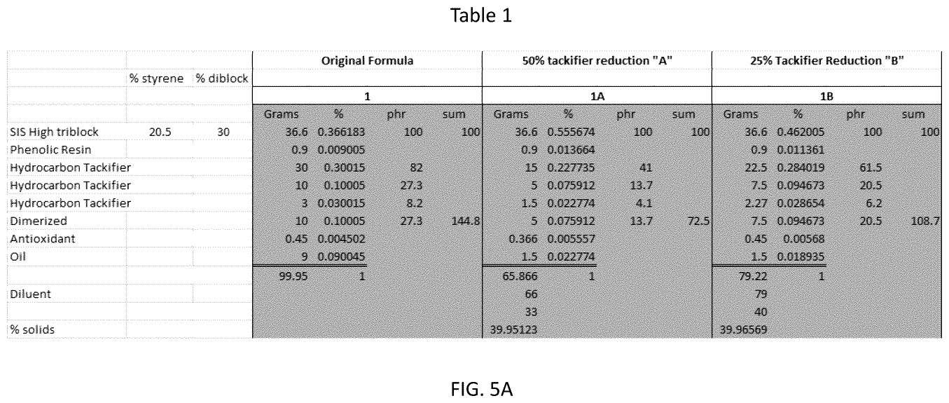

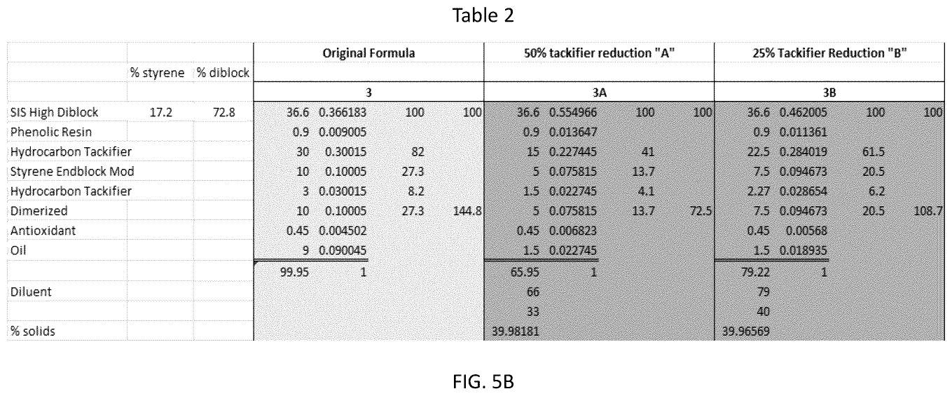

In exemplary embodiments, the tackifier added to the adhesive may include a dimerized rosin. The dimerized rosin may be Dymerex, though other compounds known to one skilled in the art may be used in addition and/or in lieu of the compounds listed above. Dymerex may increase adhesive properties to metals to allow more secure adhesion of the tape 10 to duct surfaces. Moreover, use of Dymerex in the adhesive may prevent delamination of the adhesive layer from the foil layer, as shown in FIG. 5. A concentration of the dimerized rosin may be approximately in a range of about 7% to about 10% of the total weight percentage of the adhesive, and/or approximately in a range of about 7.6% to about 9.5% of the total weight percentage of the adhesive.

In exemplary embodiments, additives may be added to the adhesive formulation to improve tackiness and shear adhesion of the tape 10. Some exemplary embodiments of such additives may include oil and/or antioxidants. In some embodiments, Calsol 5550 or Chem Hyprene L500 may be used as an oil in the formulation of the additive. A concentration of the oil may be in approximately in a range of about 1.89% to about 2.3%. In some embodiments, BNX 1000 may be used as the antioxidant. A concentration of the antioxidant may be in approximately in a range of about 0.45% to about 0.7%, and/or approximately in a range of about 0.57% to about 0.6%.

Various properties of the above-listed ingredients may be found in Technical Data Sheets that correspond to each compound, the contents of which are incorporated by reference herein in their entireties in the Appendix.

### EXAMPLES

The following examples are set forth for purposes of illustration only. Parts and percentages appearing in such examples are approximate unless otherwise stipulated.

Prior to production of the adhesive tape, concentrations of the SBCs, the tackifier, and/or the additives may be adjusted to vary adhesion properties of the adhesive. For example, in some embodiments, hot melt adhesive may delaminate from the foil of the first layer, as shown in FIG. 5. FIG. 5 illustrates a failure of some adhesive tapes in which the first layer 14 cleaves at 24′ and 26′, while the adhesive layer 16 stretches and remains intact. Such delamination may occur due to SBCs having a high film strength that may lead to anchorage failure from the foil during stretching. Delamination of the adhesive layer 16 from the foil layer 14 may cause failure in the duct components to which it is attached. As noted above, compounds such as Dymerex, among others, may be added to the adhesive to increase adhesion to metals, which may minimize the risk for delamination of the second layer 16 from the first layer 24.

Adhesive properties of the adhesive tape may be adjusted. For example, Comparative Example 1, listed below, includes an exemplary embodiment of a recipe for D-336 adhesive preparation.

### Comparative Example 1—D-336 Adhesive Recipe

| Ingredient Identification | PHR | g/100 g |
|---|---|---|
| SIS Block Copolymer | 100 | 42.51 |
| Tack Resin | 114 | 48.63 |
| Antioxidant | 3 | 1.10 |
| Liquid Tack Resin | 4.9 | 2.10 |
| Oil | 13 | 5.66 |

In Comparative Example 1, the SIS Block Copolymer may be DPX 600, the tack resin may be Escorez 2203LC, the antioxidant may be BNX 1000, the liquid tack resin may be Nevtac 10, and the oil may be Calsol 850. The recipe may be adjusted for a series of trials of various compounds to determine concentration ranges for each ingredient. The series may include varying amounts of the specific ingredient being studied with the ingredients adjusted in terms of parts per 100 rubber (PHR). Lab samples in series were based on 100 grams of solids and 150 grams of liquid toluene solvent, as noted above.

### Comparative Examples 2-4

In illustrative embodiments, varying a concentration of one or more compounds in the adhesive may cause significant changes in adhesive properties thereof. For example, in some embodiments, a percentage of the tackifier in the adhesive may impact quality and adhesive duration of the tape. Table 1, provided in FIG. 5A, illustrates an adhesive composition to evaluate impact of an original formula (1) of an adhesive having a tackifier concentration thereof reduced by 50% (1A), and by 25% (1B).

As shown, an exemplary formulation of the adhesive may include an SIS High triblock (DPX 6000 block copolymer having a 20.5% styrene, 30% di-block composition), an adhesion promoter, e.g., the phenolic resin, one or more hydrocarbon tackifiers, e.g., Escorez 2203LC, Kristalex 5140, and/or Piccotex 100, a dimerized rosin, e.g., Dymerex, and one or more additives, e.g., BNX 1000 antioxidant and/or Calsol 5550 oil, among others. In illustrative embodiments, the amount of each of the tackifiers of formula (1) (Comparative Example 2) was reduced by 50% in Formula (1A) (Comparative Example 3), and 25% in Formula (1B) (Comparative Example 4), while maintaining the remaining ingredients in substantially the same amounts. Adhesive performance results of the samples in Formulas (1A) and (1B) were poor, with the tape exhibiting poor tearing and delamination from a foil surface thereof, as shown in FIG. 5, and discussed above.

### Examples 1-3

Table 2, shown in FIG. 5B, illustrates an improved adhesive of the adhesive tape 10 of the present embodiments.

As shown, Table 2 uses a different SBC (Vector 4186) than the linear block copolymer (DPX 600) of Comparative Example 2, while keeping the proportions of the remaining ingredients substantially the same. For example, Vector 4186 in formulas (3) (Example 1), (3A) (Example 2), and (3B) (Example 3) includes a 17.2% styrene, 72.8% di-block composition, which has a higher concentration of di-block than the linear block copolymer of Table 1 (30%). Superior performance of the adhesive of this formulation may be attributed to the higher di-block composition of the SBC, due to the di-blocks forming the tacky and rubbery continuous phase of the adhesive to control tack and adhesion thereof, as mentioned above. Moreover, use of Vector 4186 in lieu of other SBCs may prevent high film strength, which may lead to anchorage failure from the foil in embodiments in which the adhesive film is stretched, such as when hand tearing the tape. Lowering the film strength may allow for a cleaner cut when the tape is torn, providing less opportunity for the adhesive to decouple from the foil layer 14.

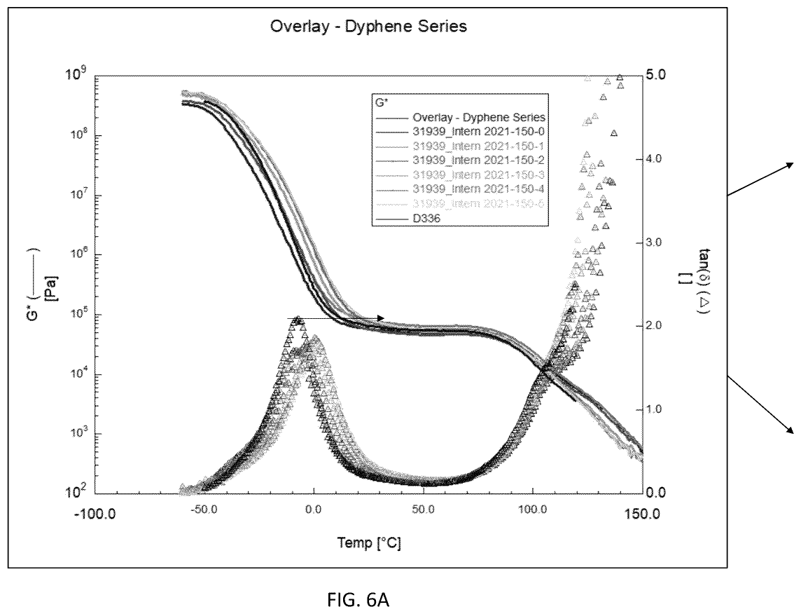

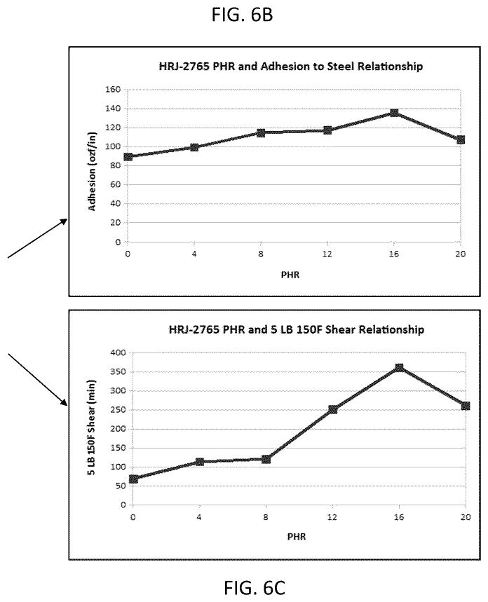

While Table 2 attempts to measure the effects of changing a concentration of the one or more tackifiers of the adhesive, concentrations of the remaining compounds may be altered to improve performance of the adhesive further. For example, FIGS. 6A-6C illustrate the effect of varying the concentration of the adhesion promoter on the adhesion properties of the adhesive. As shown in FIGS. 6B and 6C, increasing the PHR of the adhesive promoter improves adhesion to steel (FIG. 6B) and improves shear adhesion at 150 degrees Fahrenheit with a five-pound load (FIG. 6C), which are two of the physical test requirements of the UL 181A foil tape specification. For example, while increasing the PHR of the adhesion promoter causes a steady rise in adhesion performance to steel, the corresponding increase in shear adhesion at 150 degrees Fahrenheit with a five-pound load increases more than three-fold, as shown. Moreover, increasing the PHR of the adhesive promoter to a PHR value of approximately 16 provides optimal adhesion to steel (FIG. 6B) and optimal shear adhesion at 150 degrees Fahrenheit with a five-pound load (FIG. 6C). Greater concentrations of the adhesion promoter may reduce the adhesion to steel and shear adhesion at 150 degrees Fahrenheit with a five-pound load, as shown for concentrations approaching 20 PHR in FIGS. 6B and 6C.

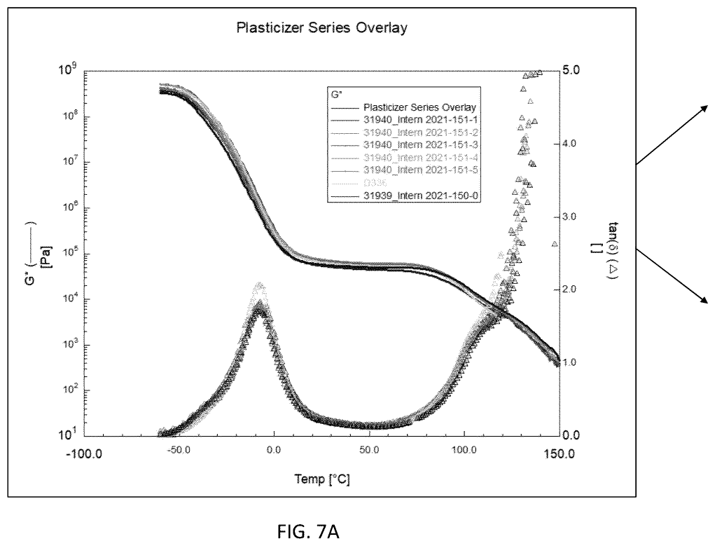

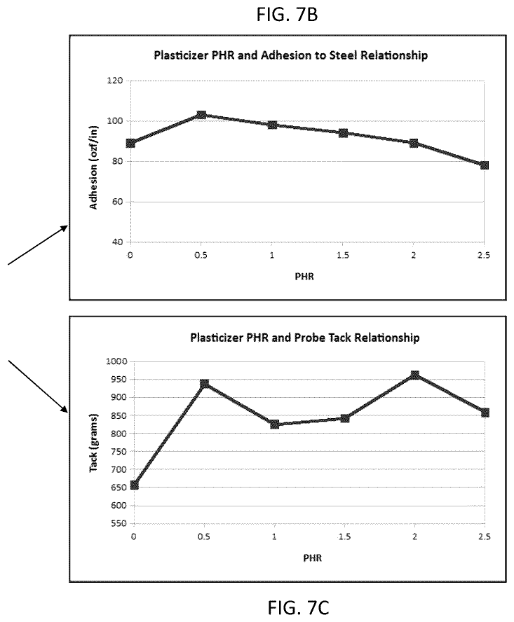

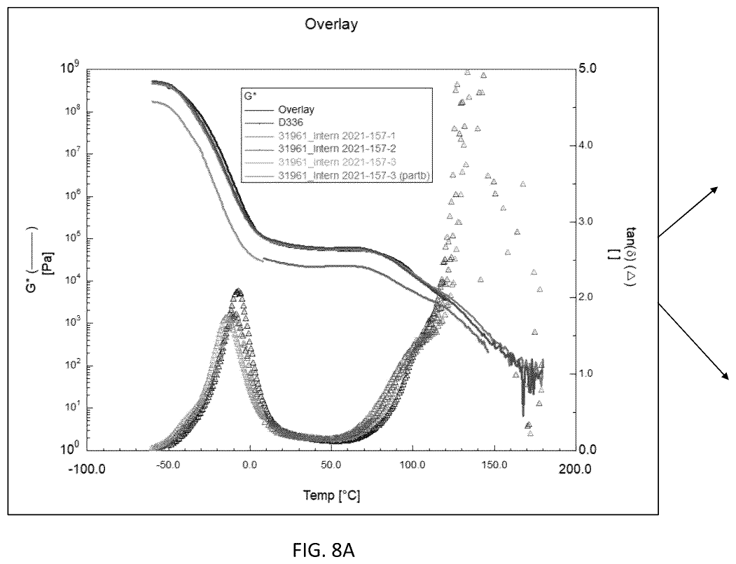

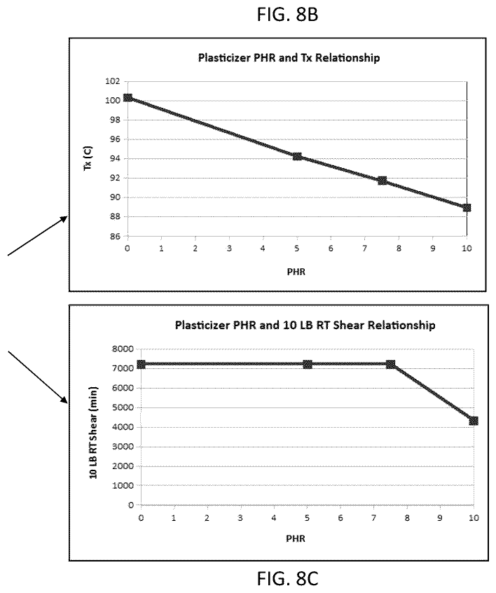

FIGS. 7A-8C illustrate the effect of varying the concentration of the plasticizer on the adhesion properties of the adhesive. As shown in FIGS. 7B and 7C, increasing the PHR of the plasticizer may decrease adhesion to steel with greater concentrations thereof (FIG. 7B) and increases probe tack relationship (FIG. 7C). For example, optimal PHR of the plasticizer for adhesion to steel may be observed at concentrations of approximately 0.5 PHR, while tack similarly peaks at approximately PHR and again at approximately 2 PHR, as shown in FIG. 7C.

In some embodiments, increasing a concentration of the plasticizer may negatively affect the adhesive, as shown in FIG. 8A. For example, use of plasticizer may decrease performance of the adhesive in high temperature environments, as shown in FIG. 8B, in which increasing the PHR of the plasticizer results in a steady decline of temperature performance with higher concentrations of plasticizer. Addition of a plasticizer can make the adhesive soft and tacky, with excessive use of plasticizer contributing to loss of shear performance. For example, shear adhesion at 150 degrees Fahrenheit with a five-pound load is seen to be constant for approximately 7,000 min, but then begins to drop at plasticizer concentrations of approximately 7.5 PHR or greater.

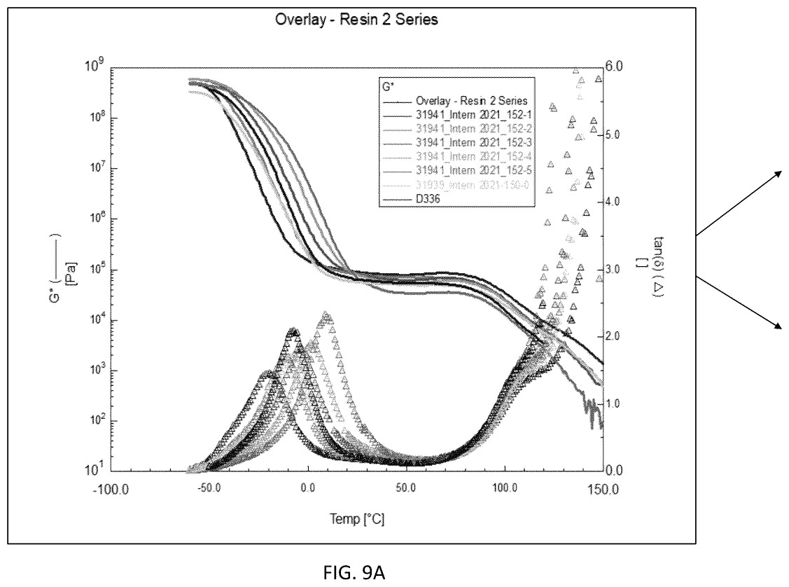

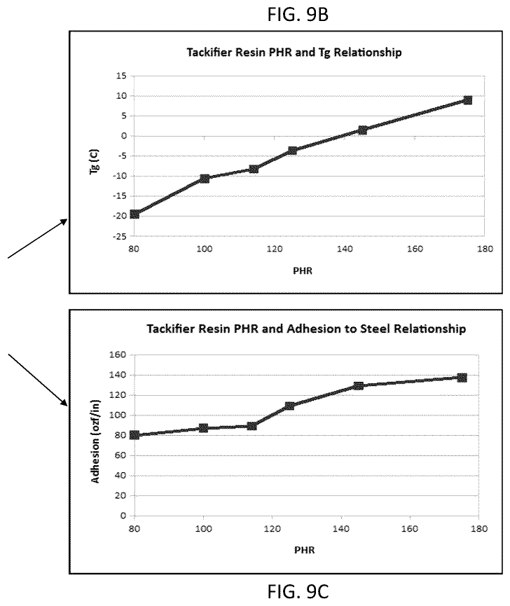

FIGS. 9A-9C illustrate the effect of varying the concentration of the tackifier resin on the adhesion properties of the adhesive. As shown in FIGS. 9B and 9C, increasing a concentration of the tackifier resin may improve temperature performance and increase adhesion to steel, though excessive use of tackifier resin can have a detrimental effect on the low temperature properties and shear performance. For example, optimal PHR of the tackifier resin may be observed increasing towards values of 180 PHR (FIG. 9B), while similar improvement is observed in this range for the adhesion to steel relationship (FIG. 9C).

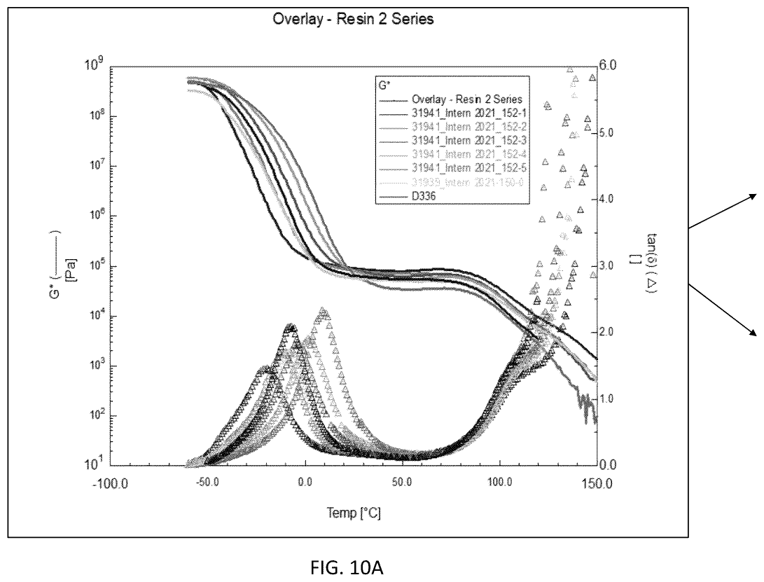

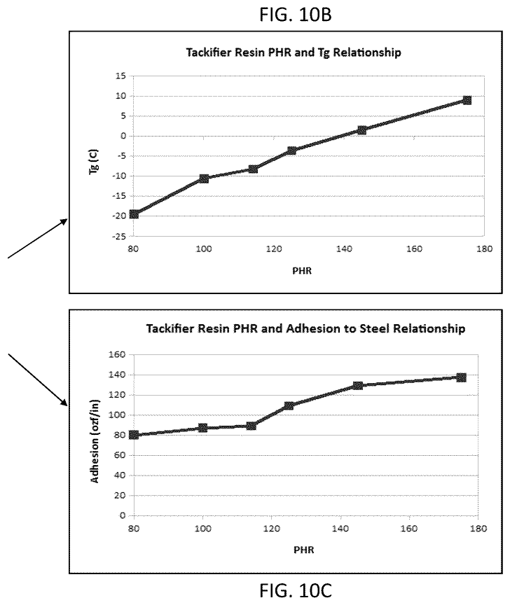

FIGS. 10A-10C illustrate the effect of varying the concentration of the endblock modifier on the adhesion properties of the adhesive. As shown in FIGS. 10B and 10C, increasing the PHR of the endblock modifier may increase the softening point of the adhesive (FIG. 10B), and increase high temperature performance of the adhesive (FIG. 10C), though excessive amounts of endblock modifier can harden the adhesive such that tack is lost. For example, optimal PHR of the endblock modifier concentrations may be observed for PHR values of approximately 15-20, while optimal PHR of the endblock modifier with respect to shear adhesion at 150 degrees Fahrenheit with a five-pound load may be observed at values of approximately 15 PHR, with further increases in the endblock modifier resulting in a decrease in shear adhesion performance. In some embodiments, values of the endblock modifier that are above 20 PHR may result in excess softening of the adhesive and further decreases in quality of performance of the adhesive under high temperatures.

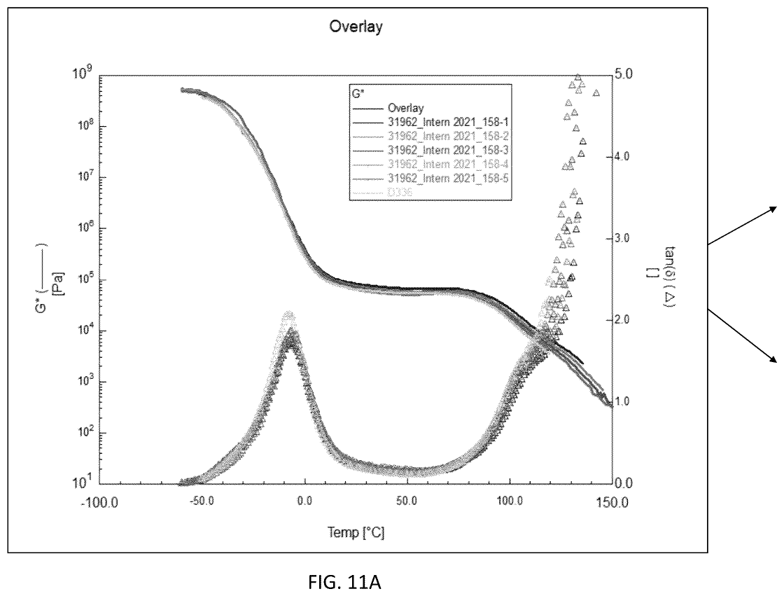

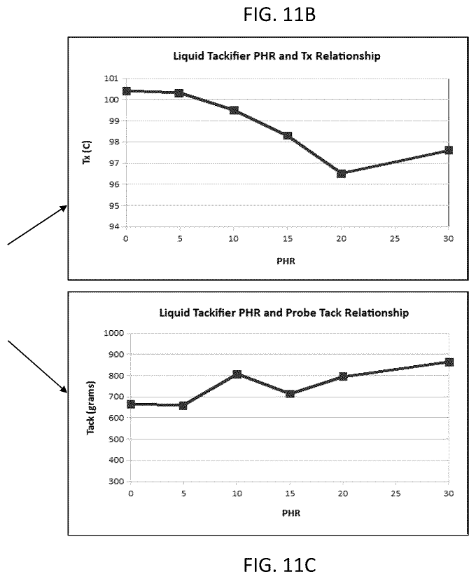

FIGS. 11A-11C illustrate the effect of varying the concentration of the liquid tackifier on the adhesion properties of the adhesive. As shown in FIGS. 11B and 11C, increasing the PHR of the liquid tackier may decrease performance of the adhesive in high temperature environments, as shown in FIG. 11B, in which increasing the PHR of the liquid tackifier results in a steady decline of temperature performance with higher concentrations of the liquid tackifier, with excessive amounts causing deterioration of shear properties. In some embodiments, increasing the PHR of the liquid tackifier may increase the tack (FIG. 11C). For example, for liquid tackifier PHR values up to approximately 20, a steady decline of high temperature performance of the adhesive may be observed (FIG. 11B), while steady improvement of tack may be observed for increasing PHR values up to approximately 30 (FIG. 11C).

### Examples 4-5

For example, Adhesive A and B of Table 3, presented below, illustrate an exemplary embodiment of the adhesive of the presently disclosed adhesive tape that includes further improvements to the performance of the adhesive in formulas (3A) (Example 4) and (3B) (Example 5), discussed in Table 2 in FIG. 5B, following the varying of concentrations in FIGS. 6A-10C.

TABLE 3

| | Adhesive A | | Adhesive B | |
|---|---|---|---|---|
| | Wt % | PHR | Wt % | PHR |
| SIS High Di-block | 55.5% | 100 | 46.2% | 100 |
| Radial, TSRC | | | | |
| Phenolic Resin, | 1.4% | 2.46 | 1.1% | 2.46 |
| Adhesion Promoter | | | | |
| Hydrocarbon Tackifier | 22.7% | 40.98 | 28.4% | 61.48 |
| Hydrocarbon Tackifier | 2.3% | 4.1 | 2.9% | 6.2 |
| Dimerized Rosin | 7.6% | 13.66 | 9.5% | 20.49 |
| Styrene Endblock | 7.6% | 13.66 | 9.5% | 20.49 |
| Modifier | | | | |
| Antioxidant | 0.7% | 1.23 | 0.6% | 1.23 |
| Oil | 2.3% | 4.1 | 1.9% | 4.1 |
| Tackifier Total | 34.0% | 61.2 | 41.9% | 90.63 |

As shown, Samples A and B may include a SIS High Di-block Radial (Vector 4186), an adhesion promoter (phenolic resin HRJ-2765), hydrocarbon tackifiers (Escorez 2203LC and Piccotex 100), dimerized rosin (Dymerex), styrene endblock modifier (Kristalex 5140), antioxidant (BNX 1000), and oil (Calsol 5550). The raw ingredients and relative concentrations of the compounds in Samples A and B represent adhesive formulation of the hot melt adhesive used in UL 181A compliant tape.

Samples A and B, as presented above, exhibit superior performance to those discussed with respect to Comparative Examples 2-4 above for a variety of reasons. For example, adjusting the adhesive includes reducing the tackifier sufficiently to improve hot shear while maintaining the tack.

### Example 6

In some exemplary embodiments, further modifications may be made to samples A and B of Examples 4 and 5 to further optimize adhesion properties of the adhesive. For example, Table 4, reproduced below, provides an exemplary adhesive formulation that is superior to Samples A and B of Examples 4 and 5, above.

TABLE 4

| Compound | Amount (#) | % |
|---|---|---|
| RUB, VECTOR 4186A SIS | 462.0 | 46.20 |
| *TAC, RESIN ESCZ 2203LC SS | 312.7 | 31.27 |
| TAC, RESIN HRJ 2765 | 11.4 | 1.14 |
| TAC, RESIN SUMMIT ROSIN P-95 | 94.7 | 9.47 |
| PLASTOLYN 290LV | 94.7 | 9.47 |
| RM, CHEM HYPRENE L500 BULK | 18.9 | 1.89 |
| RM, CHEM ANTIOXIDANT BNX 1000 | 5.7 | 0.57 |
| Piccotex 100 | 0.0 | 0 |
| | 1000.1 | 100 |

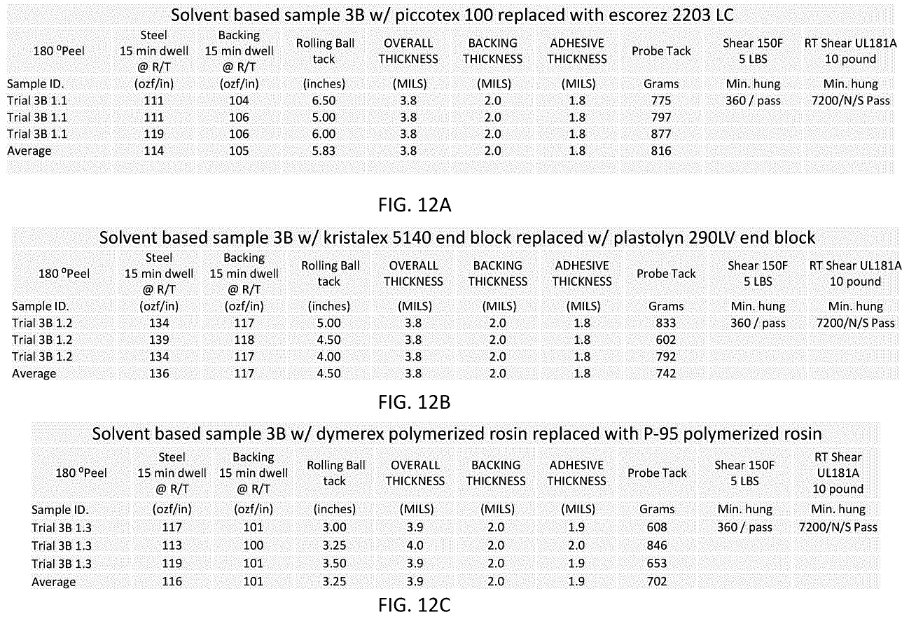

As noted above, Vector 4186 was used due to its ability to prevent high film strength, which may lead to anchorage failure from the foil in embodiments in which the adhesive film is stretched, such as when hand tearing the tape. Moreover, as shown, the adhesive of the present example (Example 6) includes increasing an amount of the Escorez tackifier resin, which may improve hot shear while maintaining a desired level of tack. To maintain an equal amount of tackifier resin, Piccotex 100 was replaced with Escorez 2203, with Escorez 2203 being more efficient and having a more substantial effect on maintaining tack of the adhesive than Piccotex 100. In some embodiments, P-Summit Rosin may be used in lieu of Dymerex to improve the heat resistance and temperature performance of the adhesive. In some embodiments, Kristalex 5140 may be replaced with Plastolyn 290LV to increase temperature performance. Trial data for the preparation of the adhesive of Example 6 may be found in FIGS. 12A-12C.

The following numbered clauses include embodiments that are contemplated and non-limiting:

Clause 1. An adhesive tape, comprising: a first layer.

Clause 2. The adhesive tape of clause 1, any other suitable clause, or any combination of suitable clauses, wherein the first layer comprises a foil.

Clause 3. The adhesive tape of clause 2, any other suitable clause, or any combination of suitable clauses, further comprising a second layer.

Clause 4. The adhesive tape of clause 3, any other suitable clause, or any combination of suitable clauses, wherein the second layer comprises an adhesive.

Clause 5. The adhesive tape of clause 4, any other suitable clause, or any combination of suitable clauses, wherein the adhesive includes a styrenic block copolymer.

Clause 6. The adhesive tape of clause 5, any other suitable clause, or any combination of suitable clauses, wherein the styrenic block copolymer is approximately in a range of about 33.8% to about 55.5% of the total weight percentage of the adhesive.

Clause 7. The adhesive tape of clause 6, any other suitable clause, or any combination of suitable clauses, wherein the adhesive includes an adhesion promoter.

Clause 8. The adhesive tape of clause 7, any other suitable clause, or any combination of suitable clauses, wherein the adhesion promoter is approximately in a range of about 1.1% to about 1.5% of the total weight percentage of the adhesive.

Clause 9. The adhesive tape of clause 8, any other suitable clause, or any combination of suitable clauses, wherein the adhesive includes an endblock modifier.

Clause 10. The adhesive tape of clause 9, any other suitable clause, or any combination of suitable clauses, wherein the endblock modifier is approximately in a range of about 7% to about 10% of the total weight percentage of the adhesive.

Clause 11. The adhesive tape of clause 10, any other suitable clause, or any combination of suitable clauses, wherein the adhesive includes a tackifier.

Clause 12. The adhesive tape of clause 11, any other suitable clause, or any combination of suitable clauses, wherein the tackifier is approximately in a range of about 20% to about 40% of the total weight percentage of the adhesive.

Clause 13. The adhesive tape of clause 12, any other suitable clause, or any combination of suitable clauses, wherein the styrenic block copolymer is approximately in a range of about 30% to about 60% of the total weight percentage of the adhesive.

Clause 14. The adhesive tape of clause 13, any other suitable clause, or any combination of suitable clauses, wherein the styrenic block copolymer is approximately in a range of about 33% to about 60% of the total weight percentage of the adhesive.

Clause 15. The adhesive tape of clause 14, any other suitable clause, or any combination of suitable clauses, wherein the styrenic block copolymer is approximately in a range of about 33% to about 55.5% of the total weight percentage of the adhesive.

Clause 16. The adhesive tape of clause 15, any other suitable clause, or any combination of suitable clauses, wherein the styrenic block copolymer is approximately in a range of about 33.5% to about 55.5% of the total weight percentage of the adhesive.

Clause 17. The adhesive tape of clause 16, any other suitable clause, or any combination of suitable clauses, wherein the styrenic block copolymer is approximately in a range of about 45.5% to about 50% of the total weight percentage of the adhesive.

Clause 18. The adhesive tape of clause 12, any other suitable clause, or any combination of suitable clauses, wherein a styrene of the styrenic block copolymer is approximately in a range of about 15% to about 20.5% of the total weight percentage of the styrenic block copolymer.

Clause 19. The adhesive tape of clause 12, any other suitable clause, or any combination of suitable clauses, wherein a di-block of the styrenic block copolymer is approximately in a range of about 25% to about 75% of the total weight percentage of the styrenic block copolymer.

Clause 20. The adhesive tape of clause 12, any other suitable clause, or any combination of suitable clauses, wherein a styrene of the styrenic block copolymer has a composition of 17.2% of the total weight percentage of the styrenic block copolymer.

Clause 21. The adhesive tape of clause 12, any other suitable clause, or any combination of suitable clauses, wherein a di-block of the styrenic block copolymer has a composition of 72.8% of the total weight percentage of the styrenic block copolymer.

Clause 22. The adhesive tape of clause 12, any other suitable clause, or any combination of suitable clauses, wherein the tape is UL181A certification compliant.

Clause 23. The adhesive tape of clause 22, any other suitable clause, or any combination of suitable clauses, wherein the tape has an adhesion to steel of greater than 60 oz/inch.

Clause 24. The adhesive tape of clause 22, any other suitable clause, or any combination of suitable clauses, wherein the tape has a shear adhesion at room temperature under a ten-pound load of greater than 120 hours while having less than 1/32-inch slip.

Clause 25. The adhesive tape of clause 22, any other suitable clause, or any combination of suitable clauses, wherein the tape has a shear adhesion at 150 degrees Fahrenheit under a five-pound load of greater than six hours while having less than 1/32-inch slip.

Clause 26. The adhesive tape of clause 12, any other suitable clause, or any combination of suitable clauses, wherein the adhesion promoter comprises one or more a phenolic resin or a thermoplastic alkylphenolic resin.

Clause 27. The adhesive tape of clause 12, any other suitable clause, or any combination of suitable clauses, wherein the end-block modifier comprises one or more aromatic hydrocarbon resins.

Clause 28. The adhesive tape of clause 12, any other suitable clause, or any combination of suitable clauses, wherein the tackifier includes one or more modified aliphatic hydrocarbon resins.

Clause 29. The adhesive tape of clause 28, any other suitable clause, or any combination of suitable clauses, wherein the tackifier includes Escorez 2203 in about 28.4% of the total weight percentage of the adhesive.

Clause 30. The adhesive tape of clause 28, any other suitable clause, or any combination of suitable clauses, wherein the tackifier includes Piccotex 100 in about 2.87% of the total weight percentage of the adhesive.

Clause 31. The adhesive tape of clause 12, any other suitable clause, or any combination of suitable clauses, further comprising one or more additives.

Clause 32. The adhesive tape of clause 12, any other suitable clause, or any combination of suitable clauses, wherein the one or more additives include an oil approximately in a range of about 1.5% to about 2.5% of the total weight percentage of the adhesive.

Clause 33. The adhesive tape of clause 31, any other suitable clause, or any combination of suitable clauses, wherein the one or more additives includes an antioxidant.

Clause 34. The adhesive tape of clause 31, any other suitable clause, or any combination of suitable clauses, wherein the antioxidant is approximately in a range of about 0.45% to about 0.7% of the total weight percentage of the adhesive.

Clause 35. The adhesive tape of clause 12, any other suitable clause, or any combination of suitable clauses, further comprising a polymerized rosin.

Clause 36. The adhesive tape of clause 35, any other suitable clause, or any combination of suitable clauses, wherein the polymerized rosin is approximately in a range of about 7.5% to about 10% of the total weight percentage of the adhesive.

Clause 37. The adhesive tape of clause 35, any other suitable clause, or any combination of suitable clauses, wherein the polymerized rosin includes one or more of Dymerex or P-95 summit rosin.

Clause 38. The adhesive tape of clause 12, any other suitable clause, or any combination of suitable clauses, further comprising a release liner layer adjacent to the adhesive layer.

Clause 39. The adhesive tape of clause 38, any other suitable clause, or any combination of suitable clauses, wherein the release liner layer is configured to detach from the adhesive layer to expose the adhesive layer to the environment.

Clause 40. The adhesive tape of clause 38, any other suitable clause, or any combination of suitable clauses, wherein the release liner layer comprises a paper coated with a silicone release agent on the adhesive side such that it attaches to the adhesive layer to block the adhesive from attaching to surfaces.

Clause 41. The adhesive tape of clause 12, any other suitable clause, or any combination of suitable clauses, wherein the styrenic block copolymer includes a pair of polystyrene endblocks separated by a rubber block.

Clause 42. The adhesive tape of clause 12, any other suitable clause, or any combination of suitable clauses, wherein each of the polystyrene endblocks form domains providing cross-linking structure.

Clause 43. An adhesive tape, comprising: a metal layer.

Clause 44. The adhesive tape of clause 43, any other suitable clause, or any combination of suitable clauses, wherein the adhesive tape includes an adhesive configured to bond the adhesive and the foil to an object.

Clause 45. The adhesive tape of clause 44, any other suitable clause, or any combination of suitable clauses, wherein the adhesive tape is UL 181A compliant.

Clause 46. The adhesive tape of clause 45, any other suitable clause, or any combination of suitable clauses, wherein the adhesive tape includes an adhesion to steel of greater than 60 oz/inch.

Clause 47. The adhesive tape of clause 46, any other suitable clause, or any combination of suitable clauses, wherein the adhesive tape includes a shear adhesion at room temperature under a ten-pound load of greater than 120 hours while having less than 1/32-inch slip.

Clause 48. The adhesive tape of clause 47, any other suitable clause, or any combination of suitable clauses, wherein and the adhesive tape includes a shear adhesion at 150 degrees Fahrenheit under a five-pound load of greater than six hours while having less than 1/32-inch slip.

Clause 49. The adhesive tape of clause 48, any other suitable clause, or any combination of suitable clauses, wherein the metal layer is adjacent to the adhesive.

Clause 50. The adhesive tape of clause 49, any other suitable clause, or any combination of suitable clauses, wherein the adhesive further comprises: a styrenic block copolymer.

Clause 51. The adhesive tape of clause 50, any other suitable clause, or any combination of suitable clauses, wherein the styrenic block copolymer is approximately in a range of about 33.8% to about 55.5% of the total weight percentage of the adhesive.

Clause 52. The adhesive tape of clause 51, any other suitable clause, or any combination of suitable clauses, wherein the adhesive tape includes an adhesion promoter.

Clause 53. The adhesive tape of clause 52, any other suitable clause, or any combination of suitable clauses, wherein the adhesion promoter is approximately in a range of about 1.1% to about 1.5% of the total weight percentage of the adhesive.

Clause 54. The adhesive tape of clause 54, any other suitable clause, or any combination of suitable clauses, wherein the adhesive tape includes an endblock modifier.

Clause 55. The adhesive tape of clause 54, any other suitable clause, or any combination of suitable clauses, wherein the endblock modifier is in approximately in a range of about 7% to about 10% of the total weight percentage of the adhesive.

Clause 56. The adhesive tape of clause 55, any other suitable clause, or any combination of suitable clauses, wherein the adhesive tape includes a tackifier.

Clause 57. The adhesive tape of clause 56, any other suitable clause, or any combination of suitable clauses, wherein the tackifier is approximately in a range of about 20% to about 40% of the total weight percentage of the adhesive.

Clause 58. The adhesive tape of clause 49, any other suitable clause, or any combination of suitable clauses, wherein the adhesive tape further comprises a release liner layer adjacent to the adhesive.

Clause 59. The adhesive tape of clause 58, any other suitable clause, or any combination of suitable clauses, wherein the release liner layer is configured to detach from the adhesive to expose the adhesive to the environment.

Clause 60. A method of making and using a hot melt adhesive tape, comprising: preparing an adhesive layer by combining one or more raw ingredients.

Clause 61. The method of clause 60, any other suitable clause, or any combination of suitable clauses, wherein the raw ingredients comprise a styrenic block copolymer.

Clause 62. The method of clause 61, any other suitable clause, or any combination of suitable clauses, wherein the styrenic block copolymer is approximately in a range of about 33.8% to about 55.5% of the total weight percentage of the adhesive;

Clause 63. The method of clause 62, any other suitable clause, or any combination of suitable clauses, wherein the raw ingredients include an adhesion promoter.

Clause 64. The method of clause 63, any other suitable clause, or any combination of suitable clauses, wherein the adhesion promoter is approximately in a range of about 1.1% to about 1.5% of the total weight percentage of the adhesive.

Clause 65. The method of clause 64, any other suitable clause, or any combination of suitable clauses, wherein the raw ingredients include an endblock modifier.

Clause 66. The method of clause 65, any other suitable clause, or any combination of suitable clauses, wherein the endblock modifier is approximately in a range of about 7% to about 10% of the total weight percentage of the adhesive.

Clause 67. The method of clause 66, any other suitable clause, or any combination of suitable clauses, wherein the raw ingredients include a tackifier.

Clause 68. The method of clause 67, any other suitable clause, or any combination of suitable clauses, wherein the tackifier is approximately in a range of about 20% to about 40% of the total weight percentage of the adhesive.

Clause 69. The method of clause 68, any other suitable clause, or any combination of suitable clauses, further comprising applying a foil layer to the adhesive layer to form the tape.

Clause 70. The method of clause 69, any other suitable clause, or any combination of suitable clauses, further comprising applying the tape to an object.

Clause 71. The method of clause 70, any other suitable clause, or any combination of suitable clauses, wherein the tape is UL181A certification compliant.

Clause 72. The method of clause 71, any other suitable clause, or any combination of suitable clauses, further comprising applying a release liner layer to the adhesive layer such that the adhesive layer is located between the release liner layer and the foil layer.

Clause 73. The method of clause 72, any other suitable clause, or any combination of suitable clauses, further comprising separating the release liner layer from the adhesive layer to expose the adhesive layer to the environment for adhering the tape to a surface.

Clause 74. The method of clause 71, any other suitable clause, or any combination of suitable clauses, wherein preparing the adhesive layer further comprises diluting the raw ingredients in liquid Toluene.

Clause 75. The method of clause 71, any other suitable clause, or any combination of suitable clauses, further comprising rolling the diluted raw ingredients to form a homogeneous mixture.

Clause 76. The method of clause 75, any other suitable clause, or any combination of suitable clauses, further comprising drawing down the homogeneous mixture to form a sheet of the adhesive layer.

Clause 77. The method of clause 76, any other suitable clause, or any combination of suitable clauses, wherein applying the foil layer to the adhesive layer further comprises laminating the adhesive layer to the foil layer.

Clause 78. A pressure sensitive hot-melt adhesive comprising: a styrenic block copolymer.

Clause 79. The pressure sensitive hot-melt adhesive of clause 78, any other suitable clause, or any combination of suitable clauses, wherein the styrenic block copolymer is approximately in a range of about 33.8% to about 55.5% of the total weight percentage of the pressure sensitive hot-melt adhesive.

Clause 80. The pressure sensitive hot-melt adhesive of clause 79, any other suitable clause, or any combination of suitable clauses, wherein the pressure sensitive hot-melt adhesive includes an adhesion promoter.

Clause 81. The pressure sensitive hot-melt adhesive of clause 80, any other suitable clause, or any combination of suitable clauses, wherein the adhesion promoter is approximately in a range of about 1.1% to about 1.5% of the total weight percentage of the pressure sensitive hot-melt adhesive.

Clause 82. The pressure sensitive hot-melt adhesive of clause 81, any other suitable clause, or any combination of suitable clauses, wherein the pressure sensitive hot-melt adhesive includes an endblock modifier.

Clause 83. The pressure sensitive hot-melt adhesive of clause 82, any other suitable clause, or any combination of suitable clauses, wherein the endblock modifier is approximately in a range of about 7% to about 10% of the total weight percentage of the pressure sensitive hot-melt adhesive.

Clause 84. The pressure sensitive hot-melt adhesive of clause 83, any other suitable clause, or any combination of suitable clauses, wherein the pressure sensitive hot-melt adhesive includes a tackifier.

Clause 85. The pressure sensitive hot-melt adhesive of clause 84, any other suitable clause, or any combination of suitable clauses, wherein the tackifier is approximately in a range of about 20% to about 40% of the total weight percentage of the pressure sensitive hot-melt adhesive.

1. An adhesive tape, comprising:
a first layer comprising a foil;
a second layer comprising an adhesive, the adhesive comprising:
a styrenic block copolymer approximately in a range of about 33.8% to about 55.5% of the total weight percentage of the adhesive;
an adhesion promoter approximately in a range of about 1.1% to about 1.5% of the total weight percentage of the adhesive;
an endblock modifier approximately in a range of about 7% to about 10% of the total weight percentage of the adhesive; and
a tackifier approximately in a range of about 20% to about 40% of the total weight percentage of the adhesive.

2. The tape of claim 1, wherein a styrene of the styrenic block copolymer is approximately in a range of about 15% to about 20.5% of the total weight percentage of the styrenic block copolymer and a di-block of the styrenic block copolymer is approximately in a range of about 25% to about 75% of the total weight percentage of the styrenic block copolymer.

3. The tape of claim 1, wherein the a styrene of the styrenic block copolymer has a composition of 17.2% of the total weight percentage of the styrenic block copolymer and a di-block of the styrenic block copolymer has a composition of 72.8% of the total weight percentage of the styrenic block copolymer.

4. The tape of claim 1, wherein the tape is UL181A certification compliant.

5. The tape of claim 1, wherein the tape has an adhesion to steel of greater than 60 oz/inch, a shear adhesion at room temperature under a ten-pound load of greater than 120 hours while having less than 1/32-inch slip, and a shear adhesion at 150 degrees Fahrenheit under a five-pound load of greater than six hours while having less than 1/32-inch slip.

6. The tape of claim 1, wherein the adhesion promoter comprises one or more a phenolic resin or a thermoplastic alkylphenolic resin.

7. The tape of claim 6, wherein the end-block modifier comprises one or more aromatic hydrocarbon resins.

8. The tape of claim 1, wherein the tackifier includes one or more modified aliphatic hydrocarbon resins.

9. The tape of claim 8, wherein the tackifier includes Escorez 2203 in about 28.4% of the total weight percentage of the adhesive and Piccotex 100 in about 2.87% of the total weight percentage of the adhesive.

10. The tape of claim 8, further comprising one or more additives including an oil approximately in a range of about 1.5% to about 2.5% of the total weight percentage of the adhesive.

11. The tape of claim 1, wherein the one or more additives includes an antioxidant approximately in a range of about 0.45% to about 0.7% of the total weight percentage of the adhesive.

12. The tape of claim 11, further comprising a polymerized rosin approximately in a range of about 7.5% to about 10% of the total weight percentage of the adhesive.

13. The tape of claim 1, wherein the polymerized rosin includes one or more of Dymerex or P-95 summit rosin.

14. The tape of claim 1, further comprising a release liner layer adjacent to the adhesive layer, wherein the release liner layer is configured to detach from the adhesive layer to expose the adhesive layer to the environment.

15. The tape of claim 14, wherein the release liner layer comprises a paper coated with a silicone release agent on the adhesive side such that it attaches to the adhesive layer to block the adhesive from attaching to surfaces.

16. The tape of claim 1, wherein the styrenic block copolymer includes a pair of polystyrene endblocks separated by a rubber block.

17. The tape of claim 16, wherein each of the polystyrene endblocks form domains providing cross-linking structure.

18. A method of making and using a hot melt adhesive tape, comprising:
preparing an adhesive layer by combining one or more raw ingredients, the raw ingredients comprising:
a styrenic block copolymer approximately in a range of about 33.8% to about 55.5% of the total weight percentage of the adhesive;
an adhesion promoter approximately in a range of about 1.1% to about 1.5% of the total weight percentage of the adhesive;
an endblock modifier approximately in a range of about 7% to about 10% of the total weight percentage of the adhesive; and
a tackifier approximately in a range of about 20% to about 40% of the total weight percentage of the adhesive;
applying a foil layer to the adhesive layer to form the tape, and
applying the tape to an object,
wherein the tape is UL181A certification compliant.

19. The method of claim 18, wherein applying the foil layer to the adhesive layer further comprises laminating the adhesive layer to the foil layer.

20. A pressure sensitive hot-melt adhesive comprising:
a styrenic block copolymer approximately in a range of about 33.8% to about 55.5% of the total weight percentage of the pressure sensitive hot-melt adhesive;
an adhesion promoter approximately in a range of about 1.1% to about 1.5% of the total weight percentage of the pressure sensitive hot-melt adhesive;
an endblock modifier approximately in a range of about 7% to about 10% of the total weight percentage of the pressure sensitive hot-melt adhesive; and
a tackifier approximately in a range of about 20% to about 40% of the total weight percentage of the pressure sensitive hot-melt adhesive.
